(19) United States
(12) Patent Application Publication
(10) Pub. No.: US 2019/0061981 A1
(43) Pub. Date: Feb. 28, 2019

(54) SYSTEM AND METHOD FOR PROCESSING FOOD PRODUCT

(71) Applicant: F.R. DRAKE COMPANY, Waynesboro, VA (US)

(72) Inventors: Andre Richards, Charlottesville, VA (US); George E. Reed, Waynesboro, VA (US); Thomas Ivy, Smithfield, VA (US)

(21) Appl. No.: 16/114,616

(22) Filed: Aug. 28, 2018

Related U.S. Application Data
(60) Provisional application No. 62/550,844, filed on Aug. 28, 2017.

(51) Int. Cl. B65B 25/06; B65B 41/14; B65B 11/02; B65B 11/10; A22C 7/00; A22C 11/00

(52) U.S. Cl. CPC B65B 25/065; B65B 41/14; A22C 11/008; B65B 11/105; A22C 7/0076; B65B 11/025

(57) ABSTRACT

A system and method are provided for processing and packaging food product. The system includes at least a transportation system configured to move food product on a conveyor belt, and a collection system configured to receive the food product from the transportation system on a disposable conveyor sheet, and further configured to package the disposable conveyor sheet with the food product thereon on and/or in a dispenser pack.

### CROSS-REFERENCE TO RELATED APPLICATION(S) AND CLAIM(S) OF PRIORITY

This application claims the benefit of priority of U.S. Provisional Application No. 62/550,844 filed Aug. 28, 2017 entitled “Method and Apparatus for Automatically Packaging Food Products”, the complete disclosure of which is incorporated herein by reference in its entirety.

### BACKGROUND

### Field of the Invention

The present invention relates to systems and associated methods for placing food products, preferably package-ready food products, into a rolled or otherwise gathered package for later dispensing, preferably as a part of an automated fresh food preparation and delivery system. In particular embodiments, the systems and methods are directed to the packaging of fresh “patties” of food products (e.g., hamburger, vegetable patties, sausage patties) into a device for collection and storage and subsequent dispensing, preferably automated dispensing.

### Related Art

Food product preparation and distribution is obliged, like any other industry, to address consumer preference and demand. These preferences and demands can come from many sources, including, for example, a desire for “organic” product or a preference or demand for a more closely correlated “farm to fork” or “fresh” product. These preferences and demands are addressed, end-to-end, through the collaborative efforts of all participants in the food production and preparation process. In addition, producers in the food industry are under a lot of pressure to remain competitive by reducing processing costs. One well-established and known method for reducing cost is to simply reduce the number of workers and replace them, to the extent feasible and possible, with automated systems.

Also, and perhaps especially applicable to the food product field, producers try to keep their food products clean and as sanitary as possible. For example, studies have shown that any time a human touches an object such as a food product, many thousands of microbes are transferred to the object. Therefore, eliminating human contact with the food product is a significant way to reduce the amount of microbes present with the food product and increase food safety. A system that eliminates or reduces human contact with food products is highly desirable.

### BRIEF SUMMARY OF THE INVENTION

According to a first embodiment of the invention, a system is provided for processing and packaging food products. The system includes at least a transportation system configured to move the food products on a conveyor belt, and a collection system configured to receive the food products from the transportation system on a disposable conveyor sheet, and further configured to package the disposable conveyor sheet with the food products thereon on and/or in a dispenser pack.

A second embodiment of the invention provides a method for processing and packaging food products. According to the second embodiment, the method involves at least the steps of transporting the food products on a conveyor belt, receiving the transported food products on a disposable conveyor sheet, and packaging the disposable conveyor sheet with the food products thereon on and/or in a dispenser pack.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not necessarily of limitation. Many changes and modifications may be made within the scope of the embodiments herein without departing from the spirit thereof, and the embodiments herein include all such modifications.

Other aspects of the invention, including apparatus, devices, systems, processes, and the like which constitute part of the invention, will become more apparent upon reading the following detailed description of the exemplary embodiments and exemplary methods.

### BRIEF DESCRIPTION OF THE DRAWINGS

The accompanying drawings are incorporated in and constitute a part of the specification. The drawings, together with the general description given above and the detailed description of the exemplary embodiments and exemplary methods given below, serve to explain the principles of the invention. In such drawings:

FIG. 1 is an upper perspective view depicting part of an automated system (or line) for processing and packaging food products, the automated system including transportation and collection systems;

FIG. 2 is a side, fragmented view of the automated system of FIG. 1, depicting an embodiment of a layout of a buffering system of the transportation system;

FIG. 3A is a perspective view of a roll-style dispenser pack;

FIG. 3B is a perspective view of the roll-style dispenser pack of FIG. 3A housed in a box or container;

FIG. 4 is a perspective view of a dispensing system feeding a processing system, such as a processing, packaging, metering, or other system;

FIG. 5 is a side schematic view of a disposable conveyor sheet folded over food product; and

FIG. 6 is a side sectional view of food product sandwiched between first and second disposable conveyor sheets fused together.

### DETAILED DESCRIPTION OF THE EXEMPLARY EMBODIMENT(S) AND EXEMPLARY METHOD(S)

Exemplary embodiments of the invention provide a system for processing and packaging food product. The system comprises two primary parts: a transportation system and a collection system. Each part will be explained individually and in relation to one another, which will ultimately describe the whole system. The transportation and collection systems can use existing or new equipment. Together the transportation and collection systems will result in food product packaged into a dispenser pack. The dispenser pack can subsequently be installed into a device that allows the food product to be dispensed for further processing, such as cooking.

The Transportation System

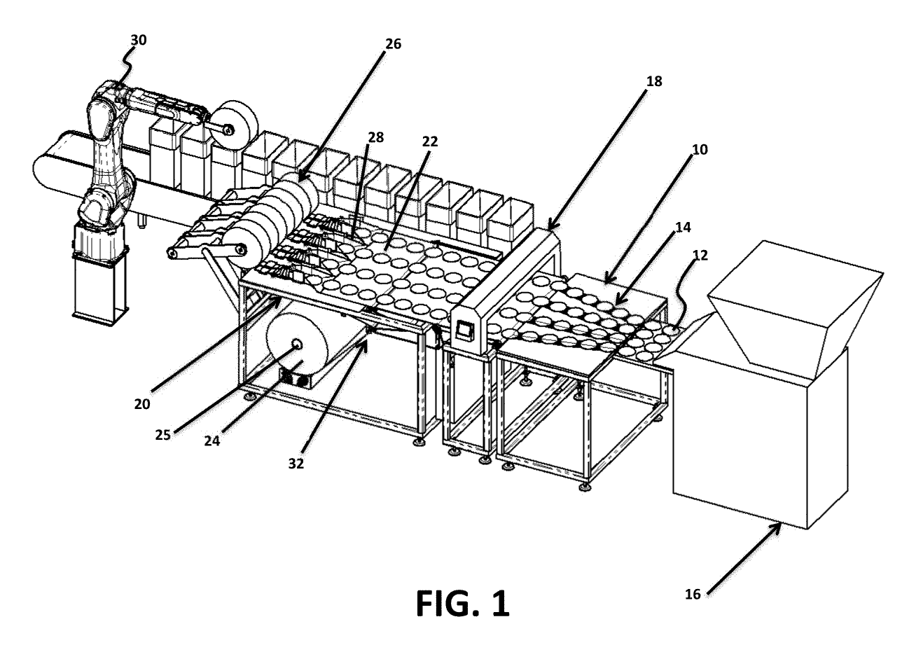

An embodiment of a transportation system is generally designated in FIG. 1 by reference numeral 10. The transportation system 10 receives food products 12, preferably package-ready food products, from a food preparation system 16. The food products 12 preferably are disc-shaped food products, such as hamburger patties, sausage patties, other meat patties, vegetable patties or food having a similar disc-like configuration.

The transportation system 10 conveys an inflow of the food products 12 received from the food preparation system 16 along conveyor belts 14, or by some other food transport device that is suitable for the food products 12 being gathered. Although four conveyor belts 14 are shown in FIG. 1, it should be understood that the transportation system 10 may include, one, two, three, or more conveyor belts. The food products 12 preferably are transported at regular and predictable intervals.

The conveyor belt(s) 14 of the transportation system 10 may receive and maintain the food product 12 in a single, undivided continuous lane. Alternatively, the conveyor belt(s) 14 of the transportation system 10 may receive the food products 12 from the food preparation system 16 in multiple (i.e., two or more) lanes or may divert the food product 12 into multiple, preferably parallel, adjacent lanes. Two or more (or all) of the lanes of the food products 12 may be transported on the same (common) conveyor belt 14. Alternatively, each of the lanes of the food products 12 may be associated with its own conveyor belt 14, as shown in FIG. 1. Although conveyor belts are used in the illustrated embodiment, it should be understood that other mechanisms of transport, e.g., a vibration table, may be used.

The lanes can include a single line (a row or column) of the food products 12 or multiple lines of the food products 12. FIG. 1 shows four lanes of single-line food products 12, each on a respective conveyor belt 14, although it should be understood that the food products 12 may be transported in one, two, three, four, five, or more lanes.

As shown in FIG. 1, in an exemplary embodiment a plurality (four as shown) of conveyor belts 14 each have a single lane of the food products 12 thereon. The four conveyor belts 14 are initially next to one another in a tight, non-spaced relationship to one another. The transportation system 10 may include a spreader for spreading the conveyor belts 14 apart from one another relative to the state in which the food products 12 are received from the food preparation system 16. Commercially available spreading conveyors may be used to spread the food products 12.

The transportation system 10 may contain additional equipment, such as an inspection station identified by reference numeral 18 in FIG. 1. The inspection station 18 can be used to examine the food product 12 for the presence of contaminants and/or foreign objects, including metal. Inspection stations are commercially available.

The Collection System

The conveyor belts 14 of the transportation system 10 deliver or feed the food products 12 to a collection system 20. Preferably, the conveyor belts 14 operate at a predetermined speed for delivering the food products 12 to the collection system 20 at a predetermined rate, e.g., a predetermined number of patties per minute.

The collection system 20 includes a disposable (e.g., single-use) conveyor sheet 22 for receiving the food products 12. The transportation system 10 and the collection system 20 may be positioned in end-to-end arrangement to cause the transfer of the food products 12 from the conveyor belts 14 directly to the disposable conveyor sheet 22. The conveyor belts 14 and the disposable conveyor sheet 22 are preferably operated at the same rates of movement to allow for continuous transfer.

The disposable conveyor sheet 22 preferably moves and receives the food products 12 without any belt thereunder. As illustrated, the disposable conveyor sheet 22 acts as a belt in as much as the disposable conveyor sheet 22 carries the food products 12, but the disposable conveyor sheet 22 is non-continuous (that is, is not endless). The disposable conveyor sheet 22 may be conveyed using a vacuum, which grips the sheet 22 and pulls the sheet 22 through the collection system 20. A commercially available vacuum conveyor may be used to move the disposal conveyor sheet 22.

The collection system 20 may include a storage facility or storage member 24 for storing the disposable conveyor sheet 22 prior to use. For example, the storage member 24 can comprise a roll, spool, or some other member or mechanism, such as a powered mandrel 25 (FIG. 1), for storing the disposable conveyor sheet 22.

The disposable conveyor sheet 22 preferably is suitable for the food products 12 transported thereon. For example, the disposable conveyor sheet 22 (and the second disposable conveyor sheet 23 discussed below) may be polyethylene film, polypropylene film, aluminum foil, food-grade wax paper, a combination thereof, or other materials. As discussed further below, the disposable conveyor sheet 22 may be a fusible material, such as polyethylene.

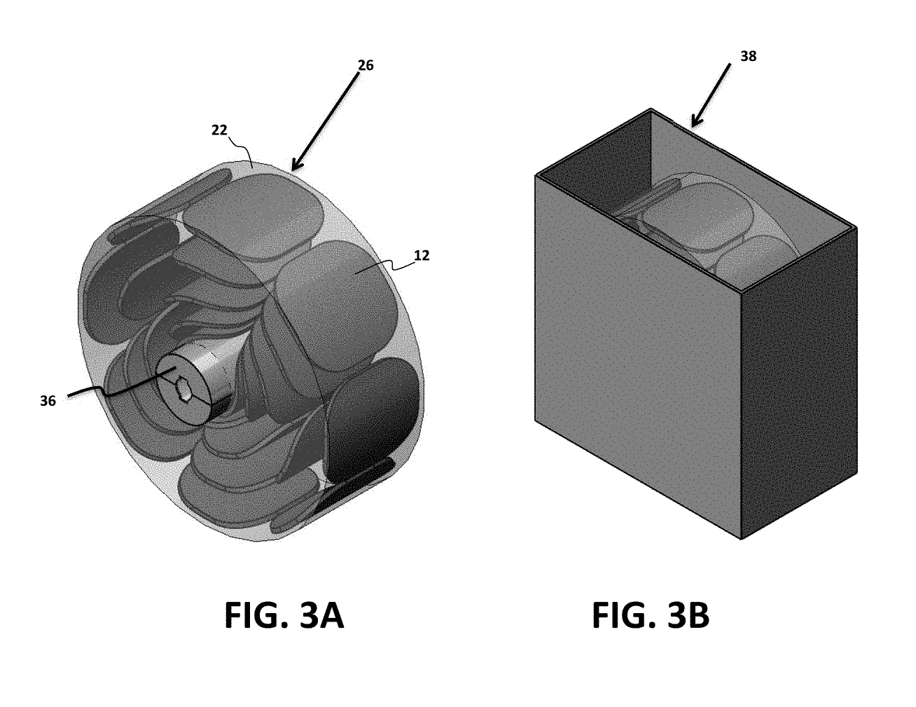

The collection system 20 accumulates the food products 12 and dispenses the food products 12 onto or into a device, referred to as a dispenser pack 26. Exemplary embodiments of dispenser packs 26 are best shown in FIGS. 3A and 3B, discussed below. The collection system 20 arranges the food products 12, preferably compactly, on and/or in the dispenser pack 26 for easy storage and transport. The food products 12 are received by the dispenser pack 26 while the food products 12 are still on the disposable conveyor sheet 22. Thus, the dispenser pack 26 stores the food products 12, together with the disposable conveyor sheet 22 on which the food products 12 are placed, preferably in a compact manner. That is, the disposable conveyor sheet 22 is, itself, incorporated into the dispenser pack 26 with the food products 12.

FIG. 3A depicts an embodiment in which the dispenser pack 26 comprises a central roller or spool 36 and the disposable conveyor sheet 22 with the food products 12 thereon is stored on the central roller or spool 36. FIG. 3B depicts an embodiment in which the dispenser pack 26 includes a modular container (optionally including the central roller or spool), such as a corrugated paperboard carton 38, in which the rolled disposable conveyor sheet 22 with the food products 12 thereon is stored.

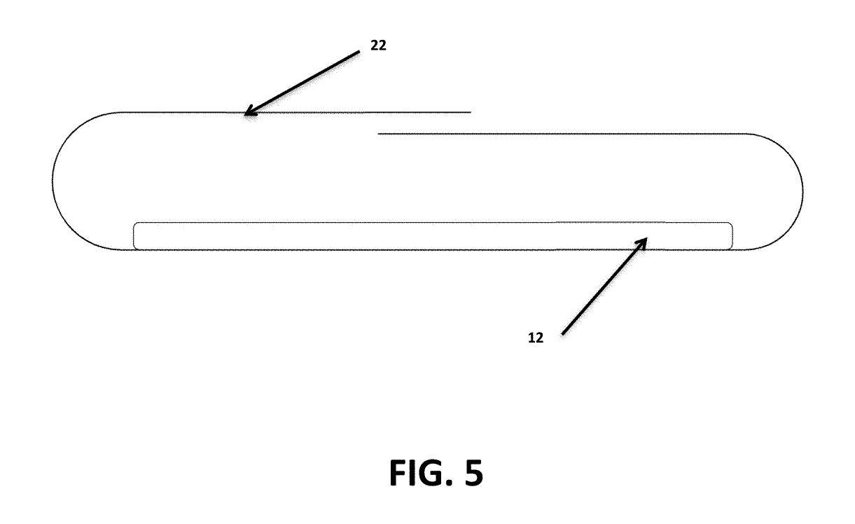

One method for compactly storing the disposable conveyor sheet 22 with the food products 12 thereon in and/or on the dispenser pack 26 is to provide the dispenser pack 26 with a roller or spool 36, and to wind the food products 12 along with the disposable conveyor sheet 22 on which the food products 12 are present around the roller or spool 36. Another method for compactly storing the disposable conveyor sheet 22 with the food products 12 thereon in and/or on the dispenser pack 26 is to fold the disposable conveyor sheet 22 with the food products 12 thereon back-and-forth onto itself in an accordion-like or serpentine manner, as shown in FIG. 5, for example into a storage container such as the carton 38 of FIG. 3B. The dispenser pack 26 will be discussed in further detail below.

The collection system 20 optionally includes cutting devices 28 for cutting the disposable conveyor sheet 22 into multiple strips (or segments), with each of the strips carrying one or more lanes of the food products 12. Each of the strips of the disposable conveyor sheet 22 may be associated with a corresponding one of the dispenser packs 26. The cut strips of the disposable conveyor sheet 22 are stored with their lane(s) of the food products 12 in corresponding dispenser packs 26. Each strip of the disposable conveyor sheet 22 thus becomes part of an associated one of the dispenser packs 26.

Alternatively, the collection system 20 may include one or more storage members (e.g., rolls) 24 carrying pre-cut or otherwise distinct strips of the disposable conveyor sheet 22. In this alternative embodiment, the transportation system 10 directly transfers the food products 12 from the conveyor belts 14 onto corresponding distinct strips of the disposable conveyor sheet 22. The distinct strips of the disposable conveyor sheet 22 are stored with their associated lane(s) of the food products 12 in corresponding dispenser packs 26. The strips of the disposable conveyor sheet 22 thus become part of the overall package or dispenser pack 26.

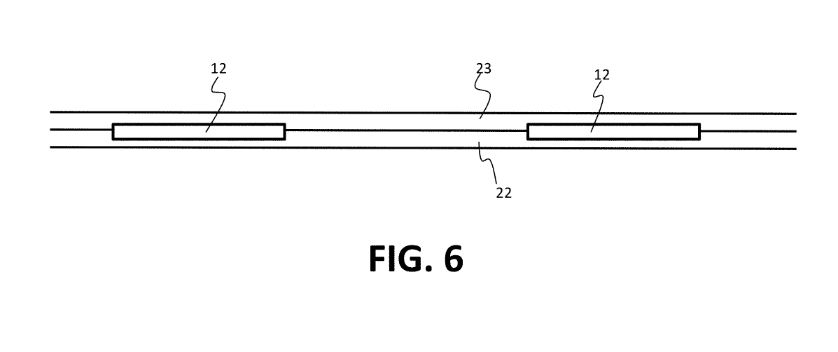

In accordance with a modification to the above-described embodiment, the food products 12 are sandwiched between the (first) disposable conveyor sheet 22 and an additional (second) disposable conveyor sheet 23 that the collection system 20 feeds onto and layers with the disposable conveyor sheet 22. The layered disposable conveyor sheets 22 and 23, best shown in FIG. 6, can be fused together, such as by applying sufficient heat and pressure to cause the layered disposable conveyor sheets 22 and 23 to become attached to one another with the food products 12 disposed therebetween and thus removed from contact while being further handled and/or transported. The fused disposable conveyor sheets 22 and 23 with the food products 12 sandwiched therebetween can then be received in the dispenser pack 26, similar to FIGS. 3A and 3B, or folded back-and-forth onto itself in an accordion-like or serpentine manner for being received in the dispenser pack 26, similar to FIG. 5.

The collection system 20 may keep track of the number of food products 12 gathered using an optical, electronic, mechanical sensor, and/or other mechanism for counting. When the desired count (e.g., a programmable number) is reached, the collection system 20 and upstream equipment stop movement of the food products 12, if necessary. Once movement of the food products 12 is stopped, the collection system 20 cuts or otherwise severs the end of the disposable conveyer sheet 22, collects the counted food products 12 on the disposable conveyor sheet 22, and closes the end of the disposable conveyor sheet 22 to keep the food product 12 from falling from the dispenser pack 26.

The Dispenser Packs

The dispenser packs 26 are units of the food products 12 that have been collected on the disposable conveyor sheet(s) 22 and arranged in a compact manner, such as in a roll or in a serpentine manner. The dispenser packs 26, as best shown in FIGS. 3A and 3B, hold the compactly arranged food products 12 and disposable conveyor sheet 22 in such a way that the food products 12 and the disposable conveyor sheet 22 can be easily stored and transported.

As shown in FIG. 3A, the dispenser pack 26 may comprise a central spindle or spool 36 that is also a functional part of the dispensing system. The spindle 36 may fit over a mandrel in the dispensing system. The mandrel may or may not be powered. The spindle 36 serves as the mechanism to transmit torque from the powered mandrel to assist the winding process and/or the unwinding process.

After the dispenser pack 26 is filled or otherwise completed, the completed dispenser pack 26 is unloaded from the collection system 20. FIG. 1 shows a robotic arm 30 for removing the completed dispenser pack 26 from the collection system 20. It should be understood that the collection system 20 may include additional robotic arms 30. Optionally, one robotic arm 30 may be provided for each of the strips of the disposable conveyor sheet 22. Alternatively, the completed dispenser packs 26 may be manually removed from the collection system 20.

The collection system 20 replaces the completed dispenser pack 26 with an empty dispenser pack (also referred to herein as a blank) that has been pre-loaded onto the collection system 20. The blank can be loaded using automated equipment, such as the robotic arm(s) 30, or may be performed manually. As the collection system 20 is loading the blank, a new blank can be readied for subsequent loading.

After the new empty dispenser pack (or blank) is inserted into place in the collection system 20, the collection system 20 may splice a free end of the disposable conveyor sheet 22 to the new empty dispenser pack. The disposable conveyor sheet 22 can be made of a material that can be joined, such as by heat fusion or by some other method, to the spindle of the empty dispenser pack. The empty dispenser pack may include, for example, a fusible strip having a first end attached to the spool 36 or spindle of the new empty dispenser pack and a second end with a leading edge that can be spliced with the free end of the disposable conveyor sheet 22.

Dispensing System

The dispenser pack 26 can be removed from the collection system 20 for transport. The food products 12 along with the disposable conveyor sheet 22, so packaged in the dispenser packs 26, are able to be dispensed directly from the dispenser packs 26 at a later time, such as when the food products 12 are ready to be cooked or reheated.

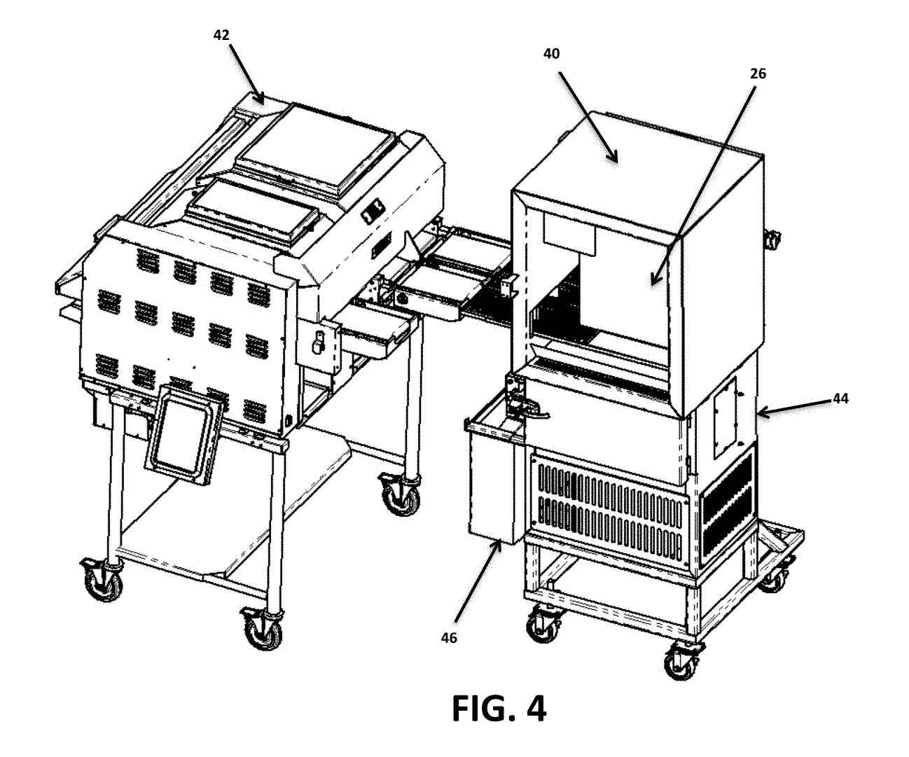

FIG. 4 depicts a dispensing system (or package system) 40 and a processing system 42. The dispensing system 40 may individually place or group the dispenser packs 26 together into a storage container, shipping container, or the like, as best shown in FIG. 4. The dispenser system 40 keeps the dispenser packs 26 of the food products 12 compactly together and protected for storage and transport. The dispenser packs 26 may be modular in nature to allow their stacking or other ordered arrangement, e.g., side-by-side, in the dispenser system 40.

The dispenser packs 26 preferably are able to be automatically loaded into the dispenser system 40 as well as automatically unloaded or dispensed into the desired process for that specific food product 12 without the need for human contact with the food product 12.

Additionally, the dispenser system 40 may provide a sealed environment. For example, the dispenser system 40 may go through a modified atmosphere packaging (MAP) process. The modified atmosphere selected may depend upon the type of the food product 12. Examples of modified atmospheres include nitrogen, carbon dioxide, and carbon monoxide. In such event, the carton 38 may be hermetically sealed to prevent leakage of the modified atmosphere.

FIG. 4 shows the dispenser system 40 including a refrigeration unit 44 and a waste bin 46 below the stored dispenser packs 26.

As shown in FIG. 4, the dispenser 40 system can feed the food products 12 in the dispenser pack(s) 26 to the downstream processing system 42, which may entail various sorts of downstream systems, including processing, packaging, metering, etc.

Buffering System

The transportation system 10 optionally is equipped with a buffering system 32 to accommodate breaks and interruptions in the production process without stopping processing of the food products 12. The buffering system 32 allows the process to continue moving the package-ready food products 12, with limited or no interruption, towards the collection system 20. Such interruptions may arise, for example, when the conveyor belt(s) 14 requires replacement. Interruptions may further arise from periodic needs to replace the disposable conveyor sheet 22 or correct an unanticipated break in the disposable conveyor sheet 22. Additionally, buffering system 32 may be used to buffer the food products 12 for a short period of time while the completed dispenser packs 26 are automatically or manually exchanged for blank dispenser packs.

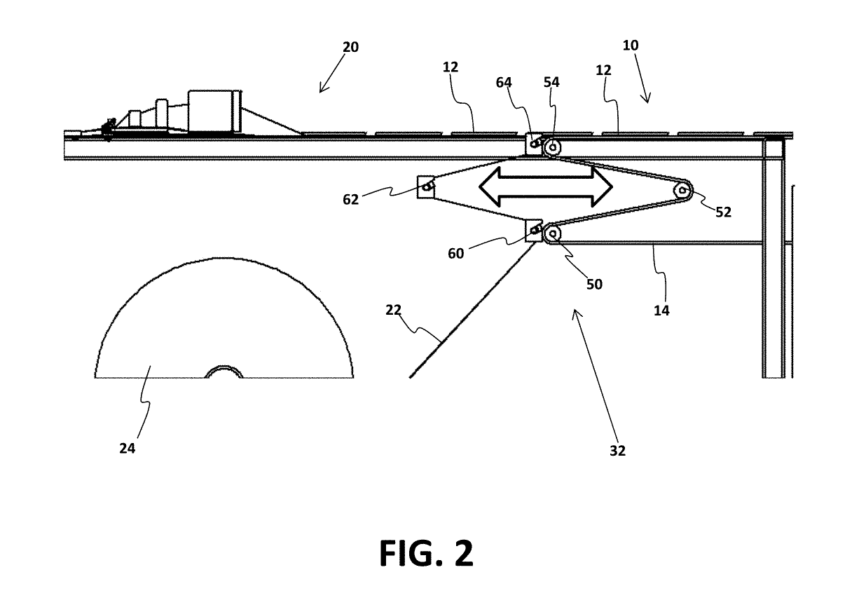

The buffering system 32, as best shown in FIG. 2, may include the capability to extend the conveyor belts 14 and retract the disposable conveyor sheet 22 in the case of an interruption while continuing movement of the food products 12 without stoppage. The buffering system 32 may further include the capability to retract the conveyor belts 14 and extend the disposable conveyor sheet 22 after the interruption has been resolved. The buffering system 32 may include various subsystems and devices to extend and/or retract, including any or all portions of the conveyor belts 14.

An embodiment of the buffering system 32 is best shown in FIG. 2. As mentioned above, the conveyor belts 14 and the disposable conveyor sheet 22 are preferably operated by the transportation system 10 and the collection system 20, respectively, at the same rate of speed. The meeting point at which the conveyor belts 14 and the disposable conveyor sheet 22 are adjacent to one another (with minor spacing therebetween to avoid direct contact) is capable of moving back and forth in the directions shown by the double-headed arrow in FIG. 2 in a process known as shuttling.

To buffer, the meeting point is moved at the same rate of speed as the conveyor belts 14 and the disposable conveyor sheet 22. Moving (or shuttling) the meeting point to the left in FIG. 2 expands the horizontal surface of the conveyor belts 14 to allow the food products 12 to be positioned onto the conveyor belt 14 for a longer period of time (before the food products 12 are transferred to the disposable conveyor sheet 22), while retracting the disposable conveyor sheet 22. The food products 12 continue to move forward (downstream) on the expanded horizontal surface of the conveyor belts 14 without transferring to the disposable conveyor sheet 22, which is retracted by a comparable distance to the expansion of the conveyor belts 14 without disrupting the upstream flow of the food products 12 on the conveyor belt 14. When the interruption has been resolved, the meeting point is shuttled back (to the right in FIG. 2) by expanding the horizontal length of the disposable conveyor sheet 22 and retracting the conveyor belts 14 to their original states. The shuttling speed during this return process is equal to the speed of movement of the conveyor belts 14 and the disposable conveyor sheet 22. As a result, during this return process, the food products 12 are transferred from the conveyor belts 14 to the disposable conveyor sheet 22 twice as fast as normal operation until the meeting point returns to its original location (shown in FIG. 2).

In the embodiment best shown in FIG. 2, the buffering system 32 includes a bottom pulley 50, a middle pulley 52, and a nose pulley 54 associated with the transportation system 10, and a bottom pulley 60, a middle pulley 62, and a nose pulley 64 associated with the collection system 20. The bottom pulleys 50 and 60 remain stationary during shuttling of the meeting point. The middle pulleys 52 and 62 and the nose pulleys 54 and 64 collectively shuttle back and forth (as shown by the double-headed arrow in FIG. 2) to move the meeting point, and thereby extend and retract the horizontal surfaces associated with the conveyor belts 14 and the disposable conveyor sheet 22. The shuttling of the pulleys 52, 54, 62, and 64 preserves the overall length of the conveyor belts 14 and the disposable conveyor sheet 22. The shuttling movement may be accomplished, for example, using a servo-driven linear actuator to move the pulleys 52, 54, 62, and 64.

An embodiment of operating the buffering system 32 is described below. As noted above, the buffering system 32 may be used to shuttle the meeting point, for example, while completed dispenser packs 26 are automatically or manually exchanged for blank (replacement) dispenser packs. During this exchange, the meeting point is shuttled to the left (in relation to FIGS. 1 and 2) to extend the horizontal surfaces of the conveyor belts 14 and retract the horizontal surfaces of the disposable conveyor sheet 22. A dancer system (not shown) of, for example three rollers, may be positioned immediately downstream of the storage member 24. The mandrel 25 is powered to feed the dancer system to create slack in the disposable conveyor sheet 22 during the exchange process. After the dispenser pack 26 has been filled, the disposable conveyor sheet 22 is cut near the completed dispenser pack 26, and a blank dispenser pack is exchanged for the completed dispenser pack 26. At the same time, the mandrel 25 and the dancer system create slack in the disposable conveyor sheet 22. Once the exchange is completed, the meeting point is shuttled back to the right back to its original position. As this shuttling takes place, the slack (created by the dancer system and the mandrel 25) in the disposable conveyor sheet 22 is taken up in order to extend the horizontal surface of the disposable conveyor sheet 22.

Preferably the above-described tasks associated with the transportation system 10 and the collection system 20 are automated (although the tasks may be performed manually) and performed without the need for any direct or indirect human contact with the food products 12 or surfaces on which the food products 12 are placed and with limited or zero break in the processing of food products 12 by earlier or subsequent manufacturing operations.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of exemplary embodiments, those skilled in the art will recognize that the embodiments herein can be practiced with modification within the spirit and scope of the appended claims.

What is claimed is:

1. A system for processing and packaging food product, comprising:
a transportation system configured to move food products on a conveyor belt; and
a collection system configured to receive the food products from the transportation system on a disposable conveyor sheet, and further configured to package the disposable conveyor sheet with the food products thereon on and/or in a dispenser pack.

2. The system of claim 1, wherein the conveyor belt comprises a plurality of conveyor belts, each configured to move one or more lanes of the food products.

3. The system of claim 2, wherein the transportation system further comprises a spreader configured to spread the conveyor belts apart from one another.

4. The system of claim 1, wherein the collection system is configured to place and store the disposable conveyor sheet and the food products thereon on and/or in the dispenser pack as a roll.

5. The system of claim 4, wherein the dispenser pack comprises a central spindle that enables winding of the disposable conveyor sheet with the food products thereon on and/or in the dispenser pack, and unwinding of the disposable conveyor sheet with the food products thereon from the dispenser pack.

6. The system of claim 1, wherein the collection system is configured to place and store the disposable conveyor sheet with the food products thereon in the dispenser pack in a serpentine manner.

7. The system of claim 1, wherein the disposable conveyor sheet comprises a fusible material.

8. The system of claim 1, wherein the disposable conveyor sheet comprises polyethylene film, polypropylene film, aluminum foil, wax paper, or a combination thereof.

9. The system of claim 1, wherein the disposable conveyor sheet comprises a first disposable conveyor sheet, and wherein the collection system is configured to apply a second disposable conveyor sheet on the first disposable conveyor sheet with the food products thereon and fuse the first and second disposable conveyor sheets together with the food products sandwiched therebetween prior to packaging the disposable conveyor sheets and the food products on and/or in the dispenser pack.

10. The system of claim 1, wherein the collection system is configured to move the disposable conveyor sheet to receive the food products without a belt under the disposable conveyor sheet.

11. A method for processing and packaging food product, comprising:
transporting food products on a conveyor belt;
receiving the transported food products on a disposable conveyor sheet; and
packaging the disposable conveyor sheet with the food products thereon on and/or in a dispenser pack.

12. The method of claim 11, wherein the conveyor belt comprises a plurality of conveyor belts, each configured to move one or more lanes of the food product.

13. The method of claim 12, further comprising spreading the conveyor belts apart from one another.

14. The method of claim 11, further comprising placing and storing the disposable conveyor sheet and the food products thereon on and/or in the dispenser pack as a roll.

15. The method of claim 14, wherein the dispenser pack comprises a central spindle that enables winding of the disposable conveyor sheet with the food products thereon on and/or in the dispenser pack, and unwinding of the disposable conveyor sheet with the food products thereon from the dispenser pack.

16. The method of claim 11, placing and storing the disposable conveyor sheet with the food products thereon in the dispenser pack in a serpentine manner.

17. The method of claim 11, wherein the disposable conveyor sheet comprises a fusible material.

18. The method of claim 11, wherein the disposable conveyor sheet comprises polyethylene film, polypropylene film, aluminum foil, wax paper, or a combination thereof.

19. The method of claim 11, wherein the disposable conveyor sheet comprises a first disposable conveyor sheet, and wherein the method further comprises applying a second disposable conveyor sheet on the first disposable conveyor sheet with the food product thereon, and fusing the first and second disposable conveyor sheets together with the food product sandwiched therebetween prior said packaging.

20. The method of claim 11, further comprising moving the disposable conveyor sheet to receive the food product without a belt under the disposable conveyor sheet.
